(19) United States
(12) Patent Application Publication
(10) Pub. No.: US 2023/0374358 A1
(43) Pub. Date: Nov. 23, 2023

(54) ONE-COMPONENT POLYURETHANE ADHESIVE

(71) Applicant: DDP SPECIALTY ELECTRONIC MATERIALS US, LLC, Wilmington, DE (US)

(72) Inventors: HUIDE ZHU, AUBURN HILLS, MI (US); DANIEL SOPHIEA, AUBURN HILLS, MI (US); THOMAS CLARK, AUBURN HILLS, MI (US); MATTHEW FELDPAUSCH, AUBURN HILLS, MI (US)

(21) Appl. No.: 18/031,454

(22) PCT Filed: Aug. 18, 2021
(86) PCT No.: PCT/US2021/046487

§ 371 Date: Apr. 12, 2023

Related U.S. Application Data
(60) Provisional application No. 63/091,882, filed on Oct. 14, 2020.

(51) Int. Cl. C09J 175/12; C08G 18/12; C08G 18/24; C08G 18/22; C08G 18/20; C08G 18/16; C08G 18/76; C08G 18/73; C08G 18/80; C08G 18/28; C08K 13/02; C09J 11/04; C09J 11/06

(52) U.S. Cl. CPC C09J 175/12; C08G 18/12; C08G 18/246; C08G 18/222; C08G 18/2081; C08G 18/165; C08G 18/7671; C08G 18/73; C08G 18/809; C08G 18/289; C08K 13/02; C09J 11/04; C09J 11/06; C08K 3/04

(57) ABSTRACT

Provided herein is a one-component polyurethane adhesive composition showing excellent adhesive strength on both press bent frit glass surfaces and painted metal surfaces.

### FIELD OF INVENTION

The present invention relates to the field of one-component polyurethane adhesives, particularly polyurethane adhesives for adhesion to glass and acid resistant painted substrates without the need of primer.

### BACKGROUND OF THE INVENTION

One part polyurethane adhesives are used extensively in the automotive industry, particularly to adhere the windshield to the window flange of a car body. Commercial adhesives are designed to offer both strong adhesion performance and good physical properties. Many adhesives require primers on the glass frit of the windshield and the coated window flange in order to generate good adhesive strength (lap shear values>362 psi) and good failure mode. The use of primers in an automotive OEM plant increases volatile organic compounds, production steps, quality issues and manufacturing cost.

Adhesives that provide primerless adhesion either to the glass frit or to the painted metal panel have been reported, but these adhesives lack primeless adhesion performance to both the glass frit and the painted panel, especially to both the press bent glass frit and the acid resistant painted panel.

There exists a strong need for one-component polyurethane adhesives capable of providing good primerless adhesion to both the glass frit and the painted panel.

### SUMMARY OF THE INVENTION

In a first aspect, the invention provides a one-component polyurethane adhesive composition comprising:
(A) at least one polyether prepolymer at a total content of polyether prepolymer of 30-75 wt %;
(B) at least one polyester prepolymer at a total content of polyester prepolymer of 0.5-2.0 wt %;
(C) at least one aliphatic polyisocyanate at a total aliphatic polyisocyanate content of 0.5-3.0 wt %
(D) at least one aromatic polyisocyanate at a total aromatic polyisocyanate content of 0.2-2.0 wt %
(E) at least one isocyanate functionalized silane at a total isocyanate functionalized silane content of 0.2-3.0 wt %
(F) amine catalyst at 0.1-0.6 wt %
(G) at least one mercaptosilane at a total mercaptosilane content of 0-1.5 wt % and/or (G′) at least one aminosilane at a total aminosilane content of 0-1.5 wt % wherein the combination of amino and/or mercaptosilane is at least 0.5 wt %;
(H) carbon black at 10-35 wt %;
(I) optionally calcium carbonate at 0-20 wt %
(J) optionally filler other than carbon black and calcium carbonate, at 0-20 wt %
(K) at least one organometallic catalyst capable of catalyzing the reaction of isocyanate with a functional group having at least one reactive hydrogen and silane condensation;
wherein the total polyisocyanate content is 1-5 wt %, the total of calcium carbonate plus filler is 0-20 wt %, and the weight percentages are based on the total weight of the polyurethane adhesive.

In a second aspect, the invention provides an adhered assembly comprising:
a glass substrate;
a second substrate;
a layer of an adhesive composition of the invention being adhesively in contact with both substrates.

In a third aspect, the invention provides a method for adhering a glass substrate to a second substrate, the method comprising the steps:
(1) providing a glass substrate and a second substrate;
(2) applying an adhesive composition of the invention to the glass substrate, the second substrate or both without primer;
(3) assembling the glass substrate and the second substrate such that the adhesive composition is in adhesive contact with both substrates.

The compositions of the invention are useful in bonding glass and painted substrates together without the need of primer. The composition gives lap shear strengths which meet industry standards and provides durable bonds. In a preferred embodiment the composition after cure for 7 days at 23° C., plus or minus, 2° C. exhibit a tensile strength of 6 MPa (870 psi) or greater, a Young's modulus of 3 MPa (435 psi) or greater, a lapshear adhesion strength of 2.5 MPa (362 psi) or greater with 100 percent cohesive failure, an elongation of 270% or greater and a quick knife adhesion of 100 percent cohesive failure after 7 days cure under 23° C. and 50% relative humidity and other environmental aging conditions. The compositions of the invention are pumpable at room temperature and no heating is required.

### DETAILED DESCRIPTION OF THE INVENTION

The inventors have surprisingly found that an adhesive composition according to claim 1 gives good primerless adhesion to both glass and painted substrates, even after environmental ageing conditions.
Definitions and Abbreviations
MDI 4,4′-Methylenebis(phenyl isocyanate)
HDI Hexamethylene diisocyanate
PU polyurethane
SEC size exclusion chromatography

Molecular weights of polymers as reported herein are reported in Daltons (Da) as number or weight average molecular weights, as determined by size exclusion chromatography (SEC).

The one-component polyurethane adhesive compositions of the invention comprise:
(A) at least one polyether prepolymer at a total content of polyether prepolymer of 30-75 wt %;
(B) at least one polyester prepolymer at a total content of polyester prepolymer of 0.5-2.0 wt %
(C) at least one aliphatic polyisocyanate at a total aliphatic polyisocyanate content of 0.5-3.0 wt %;
(D) at least one aromatic polyisocyanate at a total aromatic polyisocyanate content of 0.2-2.0 wt %;
(E) at least one isocyanate functionalized silane at a total isocyanate functionalized silane content of 0.2-3.0 w %;
(F) amine catalyst at 0.1-0.6 wt %;
(G) at least one mercaptosilane at a total mercaptosilane content of 0-1.5 wt % and/or (G′) at least one aminosilane at a total aminosilane content of 0-1.5 wt % wherein the combination of amino and/or mercaptosilane is at least 0.5 wt %;
(H) carbon black at 10-35 wt %;
(I) optionally calcium carbonate at 0-20 wt %;
(J) optionally filler other than carbon black and calcium carbonate, at 0-20 wt %;
(K) at least one organometallic catalyst capable of catalyzing the reaction of isocyanate with a functional group having at least one reactive hydrogen and silane condensation;
wherein the total polyisocyanate content is 1-5 wt %, the total of calcium carbonate plus filler is 0-20 wt %, and the weight percentages are based on the total weight of the polyurethane adhesive.

Polyether Prepolymer (A)

The inventive compositions comprise a polyether prepolymer at 30-75 wt %, based on the total weight of the composition.

Polyether prepolymers include polymers that are made by polymerizing one or more polyether polyols in the presence of a polyisocyanate, preferable diisocyanate. Polyether polyols useful in the invention include for example, polyether polyols, poly(alkylene carbonate)polyols, hydroxyl containing polythioethers, polymer polyols, and mixtures thereof. Polyether polyols are well-known in the art and include, for example, polyoxyethylene, polyoxypropylene, polyoxybutylene, and polytetramethylene ether diols and triols which are prepared by reacting an unsubstituted or halogen- or aromatic-substituted ethylene oxide or propylene oxide with an initiator compound containing two or more active hydrogen groups such as water, ammonia, a polyalcohol, or an amine. In general, polyether polyols may be prepared by polymerizing alkylene oxides in the presence of an active hydrogen-containing initiator compound. Preferred polyether polyols contain one or more alkylene oxide units in the backbone of the polyol. Preferred alkylene oxide units are ethylene oxide, propylene oxide, butylene oxide and mixtures thereof. Preferably, the polyol contains propylene oxide units, ethylene oxide units or a mixture thereof. In the embodiment where a mixture of alkylene oxide units is contained in a polyol, the different units can be randomly arranged or can be arranged in blocks of each alkylene oxides. In one preferred embodiment, the polyol comprises propylene oxide chains with ethylene oxide chains capping the polyol. In a preferred embodiment, the polyether polyols are a mixture of polyether diols and polyether triols. Preferably, the polyether polyol or mixture has a functionality of at least about 1.5, more preferably at least about 1.8, and is most preferably at least about 2.0; and is preferably no greater than about 4.0, more preferably no greater than about 3.5, and is most preferably no greater than about 3.0. Preferably, the equivalent weight of the polyether polyol mixture is at least about 200, more preferably at least about 500, and is more preferably at least about 1,000; and is preferably no greater than about 5,000, more preferably no greater than about 3,000, and is most preferably no greater than about 2,500.

More specific examples include:
1. Difunctional polyols (diols), such as poly(alkylene oxide)diols, where the alkylene group is C₂ to C₄, particularly poly(ethylene oxide)diol, poly(propylene oxide)diol and poly(tetramethylene oxide)diol, with poly(propylene oxide)diol being particularly preferred. In a particularly preferred embodiment the polyether prepolymer comprises a nominally difunctional, poly(propylene oxide) having a hydroxyl number of 56 (equivalent weight 1000);
2. Trifunctional polyols (triols), such as those based on the akylene oxides initiated with a trifunctional polyol, such as trimethylolpropane, where the alkylene group is C₂ to C₄, particularly ethylene oxide, propylene oxide, tetramethylene oxide and butylene oxide, with propylene oxide being particularly preferred. In a particularly preferred embodiment, the polyether prepolymer comprises a nominally trifunctional poly(propylene oxide) having a hydroxyl number of 36 (equivalent weight 1558); the polymer may or may not be capped with ethylene oxide to modify reactivity.
3. A mixture of 1 and 2. Particularly preferred is a mixture of 1 and 2, more particularly preferred is a mixture of a) a nominally difunctional, poly(propylene oxide) having a hydroxyl number of 56 (equivalent weight 1000) and b) a nominally trifunctional poly(propylene oxide) having a hydroxyl number of 36 (equivalent weight 1558), particularly at a weight ratio b)/a) of 1:2 to 2:1.

The diisocyanate that may be used to make the polyether prepolymer is not particularly limited. Aliphatic and aromatic diisocyanates may be used. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), and isophorone diisocyanate (IPDI), with MDI being particularly preferred.

In a particularly preferred embodiment, the polyether prepolymer comprises a nominally trifunctional poly(propylene oxide) having a hydroxyl number of 56 (equivalent weight 1000) and a nominally trifunctional poly(propylene oxide) having a hydroxyl number of 36 (equivalent weight 1558), reacted with MDI.

In a preferred embodiment, the polyether prepolymer has an isocyanate content of 1.25% by weight, and a viscosity of 16,000 cps at 23° C. as measured according to the procedure described in U.S. Pat. No. 5,922,809 at column 12, lines 38 to 49.

The polyether prepolymer is present at 30-75 wt %, based on the total weight of the adhesive composition, more preferably 45-65 wt %, more particularly preferably 55-64%, based on the total weight of the adhesive.

In a particularly preferred embodiment, the adhesive composition of the invention comprises 58-64 wt % of a polyether prepolymer, based on the total weight of the adhesive composition, comprising a nominally trifunctional poly(propylene oxide) having a hydroxyl number of 36 (equivalent weight 1558) and a nominally trifunctional poly(propylene oxide) having a hydroxyl number of 56 (equivalent weight 1000), reacted with MDI, and having an isocyanate content of 1.25% by weight, and a viscosity of 16,000 cps at 23° C. as measured according to the procedure described in U.S. Pat. No. 5,922,809 at column 12, lines 38 to 49.

Preferably, prepolymer has a Brookfield viscosity of at least 6,000 centipoise or at least about 8,000 centipoise, and as much as 30,000 centipoise or as much as 20,000 centipoise. If the viscosity is too high, it will be difficult to pump the final adhesive. If the viscosity is too low, the final adhesive will be too runny and/or will sag.

The prepolymer has an isocyanate equivalent weight of at least 840, which corresponds to an NCO content of 5% by weight. The isocyanate equivalent weight of the prepolymer may be at least 1050 (NCO content 4%), at least 1400 (NCO content 3%) or at least 1680 (NCO content 2.5%), and may be up to, for example, 10,000 (NCO content 0.42%), up to 8400 (NCO content 0.5%), up to 7000 (NCO content 0.6%), up to 5000 (NCO content 0.84%).-The polyether prepolymer has an average isocyanate functionality of at least about 2.0 and molecular weights (weight average) of at least about 2,000. Preferably, the average isocyanate functionality of the prepolymer is at least about 2.2, and is more preferably at least about 2.4. Preferably, the isocyanate functionality is no greater than about 3.5, more preferably no greater than about 3.0 and most preferably no greater than about 2.8. Preferably, the weight average molecular weight of the prepolymer is at least about 2,500 and is more preferably at least about 3,000; and is preferably no greater than about 40,000, even more preferably no greater than about 20,000, more preferably no greater than about 15,000 and is most preferably no greater than about 10,000. The prepolymer may be prepared by any suitable method, such as by reacting an isocyanate-reactive compound containing at least two isocyanate-reactive, active hydrogen containing groups with an excess over stoichiometry of a polyisocyanate under reaction conditions sufficient to form the corresponding prepolymer.

Prepolymer equivalent and molecular weights are determined according to the procedure disclosed in U.S. Pat. No. 5,922,809 at column 12, lines 50 to 64, incorporated herein by reference.

Polyester Prepolymer (B)

The inventive adhesive compositions comprise a polyester prepolymer at 0.5-2.0 wt %, based on the total weight of the composition.

Polyester prepolymers include polymers that are made by reacting one or more linear copolyesters with primary hydroxyl functionality with a polyisocyanate, preferably a diisocyanate. Particularly preferred are copolyesters having molecular weight of 3,000-4,000 Da, preferably 3,500 Da.

The diisocyanate that may be used to make the polyester prepolymer is not particularly limited. Aliphatic and aromatic diisocyanates may be used. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), and isophorone diisocyanate (IPDI), with MDI being particularly preferred.

In a preferred embodiment, the polyester prepolymer is made by reacting a copolyester of molecular weight of 3,500 Da with MDI. Preferably it has a melting point of 45-90° C.

The polyester prepolymer is present at 0.5-2.0 wt %, based on the total weight of the composition, preferably at 0.9-1.5 wt %, more preferably 1 to 1.3 wt %, based on the total weight of the adhesive composition.

In a preferred embodiment, the polyester prepolymer is made by reacting a copolyester of molecular weight of 3,500 Da with MDI, has a melting point of 45-90° C., and it is used at 1 to 1.3 wt %, based on the total weight of the adhesive composition.

Aliphatic Polyisocyanate (C)

The adhesive compositions of the invention comprise at least one aliphatic polyisocyanate at a total aliphatic polyisocyanate content of 0.5-3.0 wt %.

The aliphatic polyisocyanate is not particularly limited. Some examples include isophorone diisocyanate, 1,6-hexamethylene diisocyanate, bis(4-isocyanatocyclohexyl)methane, and trimethyl hexamethylene diisocyanate, any of which can be modified to include biuret, allophonate, urea, carbamate, isocyanurate or carbodiimide groups.

In a preferred embodiment, the aliphatic polyisocyanate is based on HDI trimer having an NCO content of 21.8±0.3% (according to DIN EN ISO 11 909).

The aliphatic polyisocyanate is present in the adhesive compositions of the invention at 0.5-3.0 wt %, based on the total weight of the composition, preferably at 0.8-2.5 wt %, based on the total weight of the adhesive composition.

In a particularly preferred embodiment, the aliphatic polyisocyanate is HDI trimer having an NCO content of 21.8±0.3% (according to DIN EN ISO 11 909) at 0.8 to 2.5 wt %, based on the total weight of the adhesive composition.

Aromatic Polyisocyanate (D)

The adhesive compositions of the invention comprise (D) at least one aromatic polyisocyanate at a total aromatic polyisocyanate content of 0.2-2.0 wt %, based on the total weight of the adhesive composition.

The aromatic polyisocyanate is not particularly limited. Examples include diphenylmethane diisocyanate (MDI), polymethylene polyphenylisocyanates, polymeric MDI (PMDI, a mixture of diphenylmethane diisocyanate and polymethylene polyphenylioscyanates), tetramethylxylene diisocyanate, toluene diisocyanate, any of which can be modified to include biuret, allophonate, urea, carbamate, isocyanurate or carbodiimide groups.

In a preferred embodiment, the aromatic polyisocyanate is polymethylene polyphenylisocyanate, having an NCO content of 30.4% (according to DIN EN ISO 11 909).

The aromatic polyisocyanate is used at 0.2 to 2.0 wt %, based on the total weight of the adhesive composition, preferably at 0.3 to 0.65 wt %, based on the total weight of the adhesive composition.

In a particularly preferred embodiment the aromatic polyisocyanate is polymethylene polyphenylisocyanate, having an NCO content of 30.4% (according to DIN EN ISO 11 909) at 0.3 to 0.65 wt %, based on the total weight of the adhesive composition.

Isocyanate Functionalized Silane (E)

The adhesive compositions of the invention comprise (E) at least one isocyanate functionalized silane at a total isocyanate functionalized silane content of 0.2-3.0 wt %, based on the total weight of the adhesive composition.

The isocyanate functionalized silane is not particularly limited. Examples include those made by reacting a polyisocyanate compound, such as toluenediisocyanate, methylenediphenyl diisocyanate, with an active hydrogen-containing group W of a silane compound of the formula:

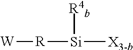

wherein W is an active hydrogen-containing group selected from the group consisting of a hydroxyl group, a carboxyl group, a mercapto group, a primary amino group and a secondary amino group, X is hydrolysable alkoxy group, R⁴ is a C₁-C₂₀ alkyl, a C₆-C₂₀ aryl, a C₁-C₂₀ aralkyl group, R is selected from C₁-C₂₀ hydrocarbon groups, particularly a propylene (—CH₂—CH₂—CH₂—) group, and b is 0, 1 or 2.

More examples include: reaction products of aminosilanes with polyisocyanates;
reaction products of mercaptosilanes with polyisocyanates;
reaction products of carboxylate functionalized silanes with polyisocyanates;
isocyanate functionalized silanes such as (3-isocyanatopropyl)trimethoxysilane.

Particularly preferred are reaction products of aminosilanes with polyisocyanates, more particularly secondary amine aminosilanes.

In a preferred embodiment, the isocyanate functionalised silane is a reaction product of a secondary aminoalkoxy silane and a polyisocyanate, for example a reaction product of N,N-bis[(3-trimethoxysilyl)-propyl]amine) reacted with HDI-Biuret.

In a particularly preferred embodiment, the isocyanate functionalised silane is a reaction product of N,N-bis[(3-trimethoxysilyl)-propyl]amine) reacted with HDI-Biuret, having an isocyanate content of 7%. The isocyanate functionalized silane may contain additional inert additives such as plasticizers

The isocyanate functionalised silane is present at 0.2-3 wt %, based on the total weight of the adhesive composition, preferably at 0.5 to 2.6 wt %, more preferably at 0.5-2.5 wt %.

In a particularly preferred embodiment, the isocyanate functionalised silane is a reaction product of N,N-bis[(3-trimethoxysilyl)-propyl]amine) reacted with HDI-Biuret, having an isocyanate content of 7% at 0.8-1.0 wt %, preferably used at 0.5-2.5 wt %, based on the total weight of the adhesive composition.

Amine Catalyst (F)

The adhesive compositions of the invention comprise (F) an amine catalyst at 0.1-0.6 wt %, based on the total weight of the adhesive composition.

The amine catalyst is any amine catalyst capable of catalysing the reaction of an isocyanate with moisture. Preferred are tertiary amines, for example aliphatic cyclic and non-cyclic tertiary amines, such as N,N-dimethylcyclohexaneamine, triethylenediamine, N,N,N,N-tetramethylalkylenediamine, N,N,N,N-pentamethyldiethylenetriamine, triethylamine, N,N-dimethylbenzylamine, N,N-dimethylhexadecylamine, N,N-dimethylbutylamine, 2,2′-dimorpholinodiethyl ether.

Particularly preferred is 2,2′-dimorpholinodiethyl ether.

The amine catalyst is used at 0.1-0.6 wt %, based on the total weight of the adhesive composition, preferably at 0.1 to 0.35 wt %, more preferably at 0.14 to 0.3 wt %.

In a preferred embodiment, the amine catalyst is 2,2′-dimorpholinodiethyl ether at 0.14 to 0.3 wt %, based on the total weight of the adhesive composition.

Mercaptosilane (G)

The adhesive compositions of the invention comprise (G) at least one mercaptosilane at 0-1.5 and/or (G′) at least one aminosilane at 0-1.5 wt % wherein the combination of amino and/or mercaptosilane is at least 0.5 wt %, based on the total weight of the adhesive composition.

The mercaptosilane is not particularly limited. Particularly preferred are mercaptosilanes of the following formula:

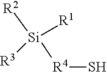

where R¹, R² and R³ are independently selected from OCH₃ and OC₂H₅;
and R⁴ is CₙH₂ₙ where n is an integer of 1 to 12.

Particularly preferred are mercaptosilanes in which R¹, R² and R³ are OCH₃ and n is 1 to 6.

In a preferred embodiment the mercaptosilane is gamma-mercaptopropyltrimethoxysilane.

The at least one mercaptosilane is preferably present at a total mercaptosilane content of 0-1.5, based on the total weight of the adhesive composition, more preferably at 0.75 to 1.2 wt %, particularly preferably at 0.75 to 1.0 wt %.

In a particularly preferred embodiment, the at least one mercaptosilane is gamma-mercaptopropyltrimethoxysilane at 0.75 to 1.0 wt %, based on the total weight of the adhesive composition.

Aminosilane (G′)

The adhesive compositions of the invention comprise (G) at least one mercaptosilane at 0-1.5 and/or (G′) at least one aminosilane at 0-1.5 wt % wherein the combination of amino and/or mercaptosilane is at least 0.5 wt %, based on the total weight of the adhesive composition.

The aminosilane is not particularly limited. Primary and secondary aminosilanes may be used. Particularly preferred are secondary, in particular aminosilanes of the following formula:

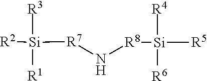

where R¹, R², R³, R⁴, R⁵ and R⁶ are independently selected from OCH₃ and OC₂H₅;
and R⁷ and R⁸ are independently selected from CₙH₂ₙ where n is an integer of 1 to 6, preferably n is 3.

In a preferred embodiment, the at least one aminosilane is bis(gamma-trimethoxysilylpropyl)amine.

The at least one aminosilane is preferably present at a total aminosilane content of 0-1.5 wt %, based on the total weight of the adhesive composition, more preferably 0.01 to 0.5 wt %, more preferably 0.05 to 0.2 wt %, more particularly preferably 0.1 to 0.15 wt %.

In a particularly preferred embodiment, the at least one aminosilane is bis(gamma-trimethoxysilylpropyl)amine at 0.09 to 0.2 wt %, based on the total weight of the adhesive composition.

Carbon Black (H)

The adhesive compositions of the invention comprise (H) carbon black at 10-35 wt %, based on the total weight of the adhesive composition.

The carbon black is not particularly limited. Preferred carbon blacks exhibit an oil absorption number of at least 80, preferably at least 90 and more preferably at least 95 cm³ of dibutyl phthalate per 100 g of carbon black, as measured according to ASTM D-2414-09. In addition, the carbon black desirably has an iodine number of at least 80, determined according to ASTM D1510-11.

The carbon black is present at 10-35 wt %, based on the total weight of the adhesive composition, preferably at 17.6 to 25 wt %, more preferably at 20 to 23 wt %.

Calcium Carbonate (I)

The adhesive compositions of the invention optionally comprise (I) calcium carbonate at 0-20 wt %, based on the total weight of the adhesive composition. The calcium carbonate particles may be untreated or surface modified by treatment with chemicals, such as organic acids or esters of organic acids.

Preferably the calcium carbonate is present at 5 to 10 wt %, more preferably at 6 to 9 wt %, based on the total weight of the adhesive composition.

The total content of calcium carbonate plus filler other than carbon black and calcium carbonate is 3-15 wt %, more preferably 5 to 12 wt % based on the total weigh of the composition.

Filler (J)

The adhesive compositions of the invention optionally comprise additional filler at 0-15 wt %, other than calcium carbonate and/or carbon black, based on the total weight of the composition.

Examples of suitable fillers include fumed silica, clay, calcium oxide, organoclay, talc, ground class, ceramics such as boron nitride, metals, cross-linked organic polymers, lignocelluosic powders.

If fumed silica is used, the particles may be untreated or surface modified by treatment with chemicals, such as chlorosilane, dichlorosilane, alkyltrialkoxysilane or polydimethylsiloxane.

The filler may be fumed silica and/or clay, which may be present at 0-20 wt %.

The total content of calcium carbonate plus filler, for example fumed silica and/or clay, is 0-20 wt %, based on the total weigh of the composition.

In a preferred embodiment, the adhesive composition of the invention comprises 0.1-1 wt % filler, more preferably 0.2-0.75 wt % particularly preferably 0.3 to 0.6 wt %, based on the total weight of the adhesive composition.

In a preferred embodiment, the filler is fumed silica, present at 0.1-1 wt %, more preferably 0.2-0.75 wt %, particularly preferably 0.3 to 0.6 wt %, based on the total weight of the adhesive composition.

Organometallic Catalyst (K)

The adhesive comprises at least one organometallic catalyst capable of catalyzing the reaction of isocyanate with a functional group having at least one reactive hydrogen and silane condensation. Metal carboxylates include tin carboxylate and zinc carboxylate. Metal alkanoates include stannous octoate, bismuth octoate or bismuth neodecanoate. Preferably the at least one organometallic catalyst is an organotin catalyst. Examples include dibutyltin dilaurate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate. In a particularly preferred embodiment, it is dimethyl tin dineodecanoate.

The organometallic catalyst is preferably present at 0.001-2 wt %, more preferably 0.005-1 wt %, particularly preferably at 0.01 to 0.5 wt %, based on the total weight of the adhesive.

In a particularly preferred embodiment, the organometallic catalyst is an organotin catalyst, particularly selected from those listed above, used at 0.01-0.5 wt %, based on the total weight of the adhesive.

In another preferred embodiment, the organometallic catalyst is dimethyl tin dineodecanoate, used at 0.01-0.5 wt %, based on the total weight of the adhesive.

Other Ingredients

The adhesive compositions of the invention may additionally comprise other ingredients, such as, for example, one or more plasticizers (such as diisononyl phthalate), one or more stabilizers, for example heat, visible light and UV-stabilizers.

Examples of heat stabilizers include alkyl substituted phenols, phosphites, sebacates and cinnamates. If present, a preferred heat stabilizer is an organophosphite and more specifically trisnonylphenyl phosphite as disclosed in U.S. Pat. No. 6,512,033, incorporated herein by reference. The heat stabilizer may constitute at least 0.01 or at least 0.3 weight percent based on the entire weight of the adhesive composition, up to at most 5 weight percent, up to 2 weight percent or up to 1.0 weight percent. The adhesive composition may be devoid of such a heat stabilizer.

For UV light stabilizers, they include benzophenones and benzotriazoles. Specific UV light absorbers include those from BASF such as TINUVIN™ P, TINUVIN™ 326, TINUVIN™ 213, TINUVIN™ 327, TINUVIN™ 571, TINUVIN™ 328, and from Cytec such as CYASORB™ UV-9, CYASORB™ UV-24, CYASORB™ UV-1164, CYASORB™ UV-2337, CYASORB™ UV-2908, CYASORB™ UV-5337, CYASORB™ UV-531, and CYASORB™ UV-3638. Among these, TINUVIN™ 571 is preferred. One or more UV light absorbers may constitute at least 0.1 weight percent, at least 0.2 weight percent or at least 0.3 parts by weight of the weight of the adhesive composition, and may constitute up to 3 weight percent, up to 2 weight percent or up to 1 weight percent thereof.

The adhesive composition of the invention may further include one or more visible light stabilizers. Preferred visible light stabilizers included hindered amine visible light stabilizers such as TINUVIN™ 144, TINUVIN™ 622, TINUVIN™ 77, TINUVIN™ 123, TINUVIN™ 765, CHIMASSORB™ 944 available from Cytec; CYASORB™ UV-500, CYASORB™ UV-3581, CYASORB™ UV-3346, all available from Ciba-Geigy. Among these, TINUVIN™ 765 is preferred choice. The visible light stabilizer(s) may constitute at least 0.1 weight percent, at least 0.2 weight percent or at least 0.3 weight percent of the adhesive composition, and may constitute up to 3 weight percent, up to 2 weight percent or up to 1.5 weight percent thereof.

In a preferred embodiment, the stabilizers comprise trisnonylphenyl phosphite, bis(1,2,2,6,6-pentamethyl-4-piperidyl)sebecate and methyl 1,2,2,6,6-pentamethyl-4-piperidyl sebecate, 2-(2H-benzotriazo-2-yl)-6-dodecyl-4-methyl-Phenol and mixtures of these, it is particularly preferred to use a mixture of these.

Viscosity

The viscosity of the adhesive composition is expressed as a press flow viscosity, which is the amount of time (in seconds) for 20 g of the adhesive composition to pass through a 4.0 mm orifice under 552 kPa applied pressure at 23° C. The press flow viscosity may be, for example, at least 5 seconds, at least 10 seconds, at least 15 seconds and may be, for example, up to 150 seconds, up to 120 seconds, up to 80 seconds or up to 70 seconds.

Adhered Assemblies

In one aspect, the invention provides an adhered assembly comprising:
a glass substrate;
a second substrate;
a layer of an adhesive composition of the invention being adhesively in contact with both substrates.

The second substrate is not particularly limited, and may be, for example, glass, metal (particularly primed metal), e-coated surfaces, painted surfaces, wood, and cured polyurethanes. In a preferred embodiment, the second substrate is selected from automotive topcoat coated surface (metal coated with automotive topcoat), e-coated surface, cured polyurethanes and cured silanated polyurethanes.

In a particularly preferred embodiment, the assembly of the invention comprises:
a glass substrate;
a substrate coated with automotive paint (such as silanated automotive paint);
a layer of an adhesive composition of the invention being adhesively in contact with both substrates.

Method of Manufacture

The adhesive compositions of the invention are made by mixing the ingredients under inert and dry conditions and/or under vacuum, until a homogenous mixture is obtained.

In one preferred method of manufacture, the polyether prepolymer, aminosilane (if used), isocyanatosilane, diisononylphthalate plasticizer (if used), aliphatic isocyanate, aromatic isocyanate and mercaptosilane (if used) are charged into a mixer vessel (such as Ross mixer), and heated to at or about 60° C., while stirring under vacuum (for example, for at or about five minutes). The amine catalyst and organometallic catalyst are added and the mixture is stirred under vacuum (for example, for at or about five minutes). The vacuum is broken and under an inert atmosphere (for example, N₂ or Ar) the filler (if used, for example fumed silica), carbon black, and calcium carbonate (if used) are added to the reactor and stirred (for example for 2-5 minutes). The filler (if used, for example fumed silica) can also be added to the mixer before carbon and calcium carbonate. The mixture is put under vacuum, and the mixture is stirred for a longer period (for example 15 minutes). The polyester prepolymer (preheated to at or about 80° C.) and stabilizers (if used) are added and vacuum is re-established and the mixture is stirred for further 5 minutes. The resulting adhesive composition may be packaged, for example, it may be packaged into airtight tubes which are stored in nitrogen filled sealed aluminium bags.

Use

The adhesive compositions of the invention are particularly suited for adhering glass to a painted or coated substrate without the need of primer.

In use, the adhesives are applied to a glass substrate and/or to the second painted substrate. If necessary, for example both substrates may be cleaned with prior to applying the adhesive. The glass substrate and the second painted substrate are then brought into adhesive contact with each other, with the adhesive of the invention sandwiched therebetween.

Curing is effected by atmospheric moisture.

### Particularly Preferred Embodiments

The following are particularly preferred embodiments of the adhesive compositions of the invention:
1. A one-component polyurethane adhesive composition comprising:
   (A) at least one polyether prepolymer at a total content of polyether prepolymer of 30-75 wt %;
   (B) at least one polyester prepolymer at a total content of polyester prepolymer of 0.5-2.0 wt %;
   (C) at least one aliphatic polyisocyanate at a total aliphatic polyisocyanate content of 0.5-3.0 wt %;
   (D) at least one aromatic polyisocyanate at a total aromatic polyisocyanate content of 0.2-2.0 wt %;
   (E) at least one isocyanate functionalized silane at a total isocyanate functionalized silane content of 0.2-3.0 wt %;
   (F) amine catalyst at 0.1-0.6 wt %;
   (G) at least one mercaptosilane at a total mercaptosilane content of 0-1.5 and/or (G′) at least one aminosilane at a total aminosilane content of 0-1.5 wt % wherein the combination of amino and/or mercaptosilane is at least 0.5 wt %;
   (H) carbon black at 10-35 wt %;
   (I) optionally calcium carbonate at 0-20 wt %;
   (J) optionally filler other than carbon black and calcium carbonate, at 0-wt %;
   (K) at least one organometallic catalyst capable of catalyzing the reaction of isocyanate with a functional group having at least one reactive hydrogen and silane condensation; wherein the total polyisocyanate content is 1-5 wt %, the total of calcium carbonate plus filler is 0-20 wt %, and the weight percentages are based on the total weight of the polyurethane adhesive.
2. An adhesive composition according to embodiment 1, wherein the at least one polyether prepolymer (A) is made by reacting one or more polyols in the presence of a polyisocyanate, preferable diisocyanate, the polyether polyol may be selected from polyether polyols, hydroxyl containing polythioethers, polymer polyols, and mixtures thereof.
3. An adhesive composition according to embodiment 1 or 2, wherein the at least one polyether prepolymer is made by reacting a polyisocyanate with a polyether polyol.
4. An adhesive composition according to embodiment 1, 2 or 3, wherein the polyether polyol is made by reacting a polyisocyanate with a polyol selected from poly(oxyethylene oxide)diol, poly(oxypropylene oxide)diol, poly(oxybutylene oxide)diol, and poly(tetramethylene oxide)diol.
5. An adhesive composition according to any one preceding embodiment, wherein the polyether prepolymer is made by reacting a polyisocyanate selected from toluene diisocyanate (TDI), hexamethylene diisocyanate (HDI), naphthalene diisocyanate (NDI), methylene bis-cyclohexylisocyanate (HMDI) (hydrogenated MDI), isophorone diisocyanate (IPDI), and mixtures of these, with a difunctional polyether polyol selected from poly(alkylene oxide)diols, where the alkylene group is C₂ to C₄, a trifunctional polyols based on poly(akylene oxide)diols initiated with a trifunctional polyol, where the alkylene group is C₂ to C₄, and mixtures of these.
6. An adhesive composition according to any one preceding embodiment, wherein the polyether prepolymer comprises a nominally trifunctional poly(propylene oxide) having a hydroxyl number of 36 (equivalent weight 1558), and a nominally difunctional poly(propylene oxide) having a hydroxyl number of 56 (equivalent weight 1000) reacted with MDI.
7. An adhesive composition according to any one preceding embodiment, wherein the at least one polyester prepolymer (B) is made by reacting one or more linear copolyesters with primary hydroxyl functionality with a polyisocyanate, preferably a diisocyanate.
8. An adhesive composition according to any one preceding embodiment, wherein the at least one polyester prepolymer (B) is made by reacting one or more linear copolyesters with primary hydroxyl functionality with a polyisocyanate selected from toluene diisocyanate (TDI), hexamethylene diisocyanate (HDI), naphthalene diisocyanate (NDI), methylene bis-cyclohexylisocyanate (HMDI) (hydrogenated MDI), isophorone diisocyanate (IPDI) and mixtures of these.
9. An adhesive composition according to any one preceding embodiment, wherein the at least one polyester prepolymer (B) is made by reacting a copolyester of molecular weight of 3,500 Da with MDI.
10. An adhesive composition according to any one preceding embodiment, wherein the at least one aliphatic polyisocyanate (C) is selected from isophorone diisocyanate, 1,6-hexamethylene diisocyanate, bis(4-isocyanatocyclohexyl)methane, and trimethyl hexamethylene diisocyanate, any of which can be modified to include biuret, allophonate, urea, carbamate, isocyanurate or carbodiimide groups.
11. An adhesive composition according to any one preceding embodiment, wherein the at least one aliphatic polyisocyanate (C) is based on HDI trimer.
12. An adhesive composition according to any one preceding embodiment, wherein the at least one aromatic polyisocyanate (D) is selected from diphenylmethane diisocyanate (MDI), polymethylene polyphenylisocyanates, polymeric MDI (PMDI, a mixture of diphenylmethane diisocyanate and polymethylene polyphenylioscyanates), tetramethylxylene diisocyanate, toluene diisocyanate, any of which can be modified to include biuret, allophonate, urea, carbamate, isocyanurate or carbodiimide groups.
13. An adhesive composition according to any one preceding embodiment, wherein the at least one aromatic polyisocyanate (D) is polymethylene polyphenylisocyanate.
14. An adhesive composition according to any one preceding embodiment, wherein the at least one isocyanate functionalized silane (E) is selected from silanes made by reacting a polyisocyanate compound, such as toluenediisocyanate, methylenediphenyl diisocyanate, with an active hydrogen-containing group W of a silane compound of the formula:

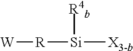

wherein W is an active hydrogen-containing group selected from the group consisting of a hydroxyl group, a carboxyl group, a mercapto group, a primary amino group and a secondary amino group, and X is hydrolysable alkoxy group. R⁴ is a C₁-C₂₀ alkyl, a C₆-C₂₀ aryl, a C₁-C₂₀ aralkyl group, R is selected from C₁-C₂₀ hydrocarbon groups, particularly a propylene (—CH₂CH₂CH₂—) group, and b is 0, 1 or 2.
15. An adhesive composition according to any one preceding embodiment, wherein the at least one isocyanate functionalized silane (E) is a reaction product of N,N-bis[(3-trimethoxysilyl)-propyl]amine) reacted with HDI-Biuret.
16. An adhesive composition according to any one preceding embodiment, wherein the amine catalyst (F) is a tertiary amine catalyst.
17. An adhesive composition according to any one preceding embodiment, wherein the amine catalyst (F) is selected from N,N-dimethylcyclohexane, triethylenediamine, N,N,N,N-tetramethylalkylenediamine, N,N,N,N-pentamethyldiethylenetriamine, triethylamine, N,N-dimethylbenzylamine, N,N-dimethylhexadecylamine, N,N-dimethylbutylamine, 2,2′-dimorpholinodiethyl ether, and mixtures of these.
18. An adhesive composition according to any one preceding embodiment, wherein the amine catalyst (F) is 2,2′-dimorpholinodiethyl ether.
19. An adhesive composition according to any one preceding embodiment, wherein the at least one mercaptosilane (G) is of the following formula:

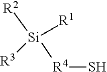

where R¹, R² and R³ are independently selected from OCH₃ and OC₂H₅;
and R⁴ is —CₙH₂ₙ— where n is an integer of 1 to 12.
20. An adhesive composition according to embodiment 19, wherein R¹, R² and R³ are OCH₃ and n is 1 to 6.
21. An adhesive composition according to any one preceding embodiment, wherein the at least one mercaptosilane (G) is gamma-mercaptopropyltrimethoxysilane.
22. An adhesive composition according to any one preceding embodiment, wherein the at least one aminosilane (G′) is of the following formula:

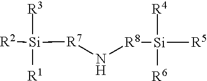

where R¹, R², R³, R⁴, R⁵ and R⁶ are independently selected from OCH₃ and OC₂H₅;
and R⁷ and Fe are independently selected from —CₙH₂ₙ— where n is an integer of 1 to 6.
23. An adhesive composition according to embodiment 22, wherein n is 3.
24. An adhesive composition according to any one preceding embodiment, wherein the at least one polyether prepolymer is present at 45-65 wt %, based on the total weight of the adhesive composition.
25. An adhesive composition according to any one preceding embodiment, wherein the at least one polyether prepolymer is present at 58-64 wt %, based on the total weight of the adhesive composition.
26. An adhesive composition according to any one preceding embodiment, wherein the at least one polyester prepolymer is present at 0.9-1.5 wt %, based on the total weight of the adhesive composition.
27. An adhesive composition according to any one preceding embodiment, wherein the at least one polyester prepolymer is present at 1 to 1.3 wt %, based on the total weight of the adhesive composition.
28. An adhesive composition according to any one preceding embodiment, wherein the at least one aliphatic polyisocyanate is present at 0.5-3.0 wt %, based on the total weight of the adhesive composition.
29. An adhesive composition according to any one preceding embodiment, wherein the at least one aliphatic polyisocyanate is present at 0.8-2.5 wt %, based on the total weight of the adhesive composition.
30. An adhesive composition according to any one preceding embodiment, wherein the at least one aromatic polyisocyanate is present at 0.3 to 0.65 wt %, based on the total weight of the adhesive composition.
31. An adhesive composition according to any one preceding embodiment, wherein the at least one isocyanate functionalized silane is present at 0.5-2.8 wt %, based on the total weight of the adhesive composition.
32. An adhesive composition according to any one preceding embodiment, wherein the at least one isocyanate functionalized silane is present at 0.5-2.5 wt %, based on the total weight of the adhesive composition.
33. An adhesive composition according to any one preceding embodiment, wherein the amine catalyst is present at 0.1-0.6 wt %, based on the total weight of the adhesive composition.
34. An adhesive composition according to any one preceding embodiment, wherein the amine catalyst is present at 0.14 to 0.3 wt %, based on the total weight of the adhesive composition.
35. An adhesive composition according to any one preceding embodiment, wherein the mercaptosilane is present at 0.75 to 1.2 wt %, based on the total weight of the adhesive composition.
36. An adhesive composition according to any one preceding embodiment, wherein the mercaptosilane is present at 0.75 to 1.0 wt %, based on the total weight of the adhesive composition.
37. An adhesive composition according to any one preceding embodiment, wherein the aminosilane is present at 0.05 to 0.5 wt %, based on the total weight of the adhesive composition.
38. An adhesive composition according to any one preceding embodiment, wherein the aminosilane is present at 0.09 to 0.2 wt %, based on the total weight of the adhesive composition.
39. An adhesive composition according to any one preceding embodiment, wherein the aminosilane is present at 0.1 to 0.15 wt %, based on the total weight of the adhesive composition.
40. An adhesive composition according to any one preceding embodiment, wherein carbon black is present at 17.6 to 25 wt %, based on the total weight of the adhesive composition.
41. An adhesive composition according to any one preceding embodiment, wherein carbon black is present at 20 to 23 wt %, based on the total weight of the adhesive composition.
42. An adhesive composition according to any one preceding embodiment, wherein calcium carbonate is present at 6 to 9 wt %, based on the total weight of the adhesive composition.
43. An adhesive composition according to any one preceding embodiment, wherein the at least one organometallic catalyst is an organotin catalyst.
44. An adhesive composition according to any one preceding embodiment, wherein the at least one organometallic catalyst is selected from dibutyltin dilaurate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate and mixtures of these.
45. An adhesive composition according to any one preceding embodiment, wherein the at least one organometallic catalyst is dimethyl tin dineodecanoate.
46. An adhesive composition according to any one preceding embodiment, wherein the at least one organometallic catalyst is used at 0.01 to 0.05 wt %, based on the total weight of the adhesive composition.
47. An adhesive composition according to any one preceding embodiment, further comprising heat, visible and UV-light stabilizers.
48. An adhesive composition according to any one preceding embodiment, further comprising stabilizers selected from trisnonylphenyl phosphite, Bis(1,2,2,6,6-pentamethyl-4-piperidyl)sebecate and methyl 1,2,2,6,6-pentamethyl-4-piperidyl sebecate, 2-(2H-benzotriazo-2-yl)-6-dodecyl-4-methyl-Phenol and mixtures of these.
49. An adhesive composition according to any one preceding embodiment, further comprising at least one plasticizer.
50. An adhesive composition according to any one preceding embodiment, further comprising at least one plasticizer which is diisononyl phthalate.
51. An adhesive composition comprising:
   (A) at least one polyether prepolymer which comprises a nominally trifunctional poly(propylene oxide) having a hydroxyl number of 36 (equivalent weight 1558), and a nominally difunctional poly(propylene oxide) having a hydroxyl number of 56 (equivalent weight 1000) reacted with MDI, at a total content of polyether prepolymer of 45-65 wt %;
   (B) at least one polyester prepolymer which is made by reacting a copolyester of molecular weight of 3,500 Da with MDI at a total content of polyester prepolymer of 0.5-2.0 wt %;
   (C) at least one aliphatic polyisocyanate which is based on HDI trimer at a total aliphatic polyisocyanate content of 0.75-2.5 wt %;
   (D) at least one aromatic polyisocyanate which is polymethylene polyphenylisocyanate at a total aromatic polyisocyanate content of 0.2-2.0 wt %;
   (E) at least one isocyanate functionalized silane which is a reaction product of N,N-bis[(3-trimethoxysilyl)-propyl]amine) reacted with HDI-Biuret, at a total isocyanate functionalized silane content of 0.5 to 2.6 wt %;
   (F) amine catalyst which is 2,2′-dimorpholinodiethyl ether at 0.1 to 0.35 wt %;
   (G) at least one mercaptosilane which is gamma-mercaptopropyltrimethoxysilane at a total mercaptosilane content of 0-1.5 and/or (G′) at least one aminosilane which is bis(gamma-trimethoxysilylpropyl)amine at a total aminosilane content of 0-1.5 wt % wherein the combination of amino and/or mercaptosilane is at least 0.5 wt %;
   (H) carbon black at 10-35 wt %;
   (I) optionally calcium carbonate at 0-20 wt %;
   (J) optionally filler other than carbon black and calcium carbonate, at 0-20 wt %;
   (K) at least one organometallic catalyst which is dimethyl tin dineodecanoate;
   wherein the total polyisocyanate content is 1-5 wt %, the total of calcium carbonate plus filler is 0-20 wt %, and the weight percentages are based on the total weight of the polyurethane adhesive.
52. An adhesive composition comprising:
   (A) at least one polyether prepolymer which comprises a nominally trifunctional poly(propylene oxide) having a hydroxyl number of 36 (equivalent weight 1558), and a nominally difunctional poly(propylene oxide) having a hydroxyl number of 56 (equivalent weight 1000) reacted with MDI, at a total content of polyether prepolymer of 58-64 wt %;
   (B) at least one polyester prepolymer which is made by reacting a copolyester of molecular weight of 3,500 Da with MDI at a total content of polyester prepolymer of 1 to 1.3 wt %;
   (C) at least one aliphatic polyisocyanate which is based on HDI trimer at a total aliphatic polyisocyanate content of 0.8-2.5 wt %;
   (D) at least one aromatic polyisocyanate which is polymethylene polyphenylisocyanate at a total aromatic polyisocyanate content of 0.3 to 0.65 wt %;
   (E) at least one isocyanate functionalized silane which is a reaction product of N,N-bis[(3-trimethoxysilyl)-propyl]amine) reacted with HDI-Biuret, at a total isocyanate functionalized silane content of 0.5-2.5 wt %;
   (F) amine catalyst which is 2,2′-dimorpholinodiethyl ether at 0.14 to 0.3 wt %;
   (G) at least one mercaptosilane which is gamma-mercaptopropyltrimethoxysilane at a total mercaptosilane content of 0.75 to 1.0 wt % and/or (G′) at least one aminosilane which is bis(gamma-trimethoxysilylpropyl)amine at a total aminosilane content of 0.1 to 0.15 wt %, wherein the combination of amino and/or mercaptosilane is at least 0.7 wt %;
   (H) carbon black at 20 to 23 wt %;
   (I) calcium carbonate at 6 to 12 wt %;
   (J) fumed silica at 0.3 to 0.6 wt %;
   (K) at least one organometallic catalyst which is dimethyl tin dineodecanoate at 0.01 to 0.05 wt %;
   wherein the total polyisocyanate content is 1.0-4.0 wt %, the total of calcium carbonate plus filler is 3-15 wt %, and the weight percentages are based on the total weight of the polyurethane adhesive.
53. An adhered assembly comprising:
   a glass substrate;
   a second substrate;
   a layer of an adhesive composition of any one preceding embodiment being adhesively in contact with both substrates.
54. A method for adhering a glass substrate to a second painted substrate, the method comprising the steps:
   (1) providing a glass substrate and a second painted substrate;
   (2) applying an adhesive composition of any one of embodiments 1 to 52 to the glass substrate, the second painted substrate or both;
   (3) assembling the glass substrate and the second painted substrate such that the adhesive is in adhesive contact with both substrates.

TABLE 1
Ingredients

| Trademark or | | |
|---|---|---|
| abbreviation | Chemistry | Function |
| VORANOL 220-056N | a nominally difunctional, | Ingredient in |
| POLYOL | poly(propylene oxide) having a | polyether |
| | hydroxyl number of 56 | prepolymer |
| | (equivalent weight 1000) | |
| VORANOL 232-036N | a nominally trifunctional | Ingredient in |
| POLYOL | poly(propylene oxide) having a | polyether |
| | hydroxyl number of 36 | prepolymer |
| | (equivalent weight 1558) that is | |
| | partially end-capped with | |
| | ethylene oxide | |
| MDI | 4,4′-Methylenebis(phenyl | Diisocyanate |
| | isocyanate) | |
| Dynacoll 7381 | Hydroxyl terminated saturated | Ingredient in |
| | copolyester | polyester |
| | | prepolymer |
| gamma- | gamma- | Mercaptosilane |
| mercaptopropyltri- | mercaptopropyltrimethoxysilane | (G) |
| methoxysilane | | |
| Silquest Y-9492 | bis(gamma- | Amino silane |
| | trimethoxysilylpropyl)amine | (G′) |
| Elftex S7100 | carbon black | Carbon Black |
| | | Filler (H) |
| Clay | Kaolin clay (calcined aluminium | Clay Filler |
| | silicate) | (J) |
| Calcium | CaCO₃ | Calcium |
| carbonate | | Carbonate |
| | | Filler (I) |
| Diisononyl | Diisononyl phthalate | Plasticizer |
| phthalate | | |
| DOVERPHOS 4 | trisnonylphenyl phosphite | Stabilizer |
| TINUVIN 765 | Mixture of Bis(1,2,2,6,6- | Stabilizer |
| | pentamethyl-4- | |
| | piperidyl)sebecate and methyl | |
| | 1,2,2,6,6-pentamethyl-4- | |
| | piperidyl sebecate | |
| TINUVIN 571 | 2-(2H-benzotriazo-2-yl)-6- | Stabilizer |
| | dodecyl-4-methyl-Phenol | |
| DMDEE | 2,2′-dimorpholinodiethylether | Amine catalyst |
| | | (F) |
| Desmodur N 3300 | Aliphatic polyisocyanate based | Aliphatic |
| | on HDI trimer, having an NCO | polyisocyanate |
| | content of 21.8 ± 0.3% | (C) |
| | (according to DIN EN ISO 11 | |
| | 909) | |
| HDI | Hexamethylene diisocyanate | Aliphatic |
| | | polyisocyanate |
| PAPI 20 | A polymethylene | Aromatic |
| | polyphenylisocyanate, having an | polyisocyanate |
| | NCO content of 30.4% | (D) |
| | (according to DIN EN ISO 11 | |
| | 909) | |
| Desmodur N-100 | Aliphatic polyisocyanate (HDI | Ingredient in |
| | Biuret) used to make isocyanate | isocyanate |
| | functionalised silane | functionalised |
| | | silane |
| Fomrez UL-28 | dimethyltin dineodecanoate | Tin catalyst |
| KKAT 670 | Zinc carboxylate | Catalyst |
| Cabosil TS720 | Fumed silica surface treated with | Filler (J) |
| | polydimethylsiloxane (PDMS). | |

### Examples

Polyether prepolymer (A): 363.68 g of Voranol 220-056 polyol, 527.04 g of Voranol 232-036 polyol and 32 g of diisononyl phthalate were charged into a 4-liter kettle, mixed and heated to 54° C. under nitrogen. All subsequent steps were performed under nitrogen. 160.64 g of molten MDI was added and mixed in. 0.08 g of stannous octoate catalyst was added drop wise. The temperature in the kettle rose due to the exothermic heat of reaction; the reaction mixture was maintained between 80° C. and 90° C. for 30 minutes. The reaction mixture was then cooled to 60° C. and 501.20 g of diisononyl phthalate and 15.36 g of diethyl malonate were added and mixed in for 30 minutes, followed by cooling to room temperature. The resulting polyether based polyurethane prepolymer had an isocyanate content of 1.25% by weight and a viscosity of 16,000 cps at 23° C. as measured according to the procedure disclosed in U.S. Pat. No. 5,922,809 at column 12, lines 38 to 49.

Polyester prepolymer (B): 280 g diisononylphthalate was charged into a vessel and heated to 50° C. under nitrogen. 172.80 g MDI was added, followed by molten Dynacoll 7381, added slowly. The mixture was stirred and allowed to react for 40 minutes between 80 to 90° C. The resulting prepolymers was allowed to cool and was stored under an inert atmosphere. The polyester prepolymer had an NCO content of 2 wt %, based on the total weight of the prepolymer.

Isocyanate functionalised silane (E): A reaction product of a secondary aminoalkoxy silane and a polyisocyanate was prepared by charging a reactor with 333.3 g diisononylphthalate under nitrogen. 729.75 g of Desmodur N-100 (a solvent free aliphatic polyisocyanate resin based on hexamethylene diisocyanate-biuret) was added and the mixture was thoroughly mixed and purged under an N₂ blanket. 436.95 g of N,N-bis[(3-trimethoxysilyl)-propyl]amine) was slowly added to the mixture, and the mixture was allowed to react for 30 minutes under nitrogen. The adduct had an isocyanate content of 7.1 wt %, based on the total weight of the adduct.

Stabilizer Mixture

140 g of Tinuvin 765, 140 g of Tinuvin 571 and 120 g of Doverphos 4 were charged into a kettle while mixing under nitrogen. The mixture was stirred for 60 minutes under nitrogen and then stored under an inert atmosphere.

Preparation of Adhesive Compositions

Using the proportions listed in Table 2, calcium carbonate and carbon black were mixed and dried at 204° C. for about 20 hours and then cooled in a closed container to form a filler mixture. The polyether prepolymer, aminosilane, isocyanate functionalized silane, diisononylphthalate, aliphatic polyisocyanate, aromatic polyisocyanate, and mercaptosilane were charged into a 2-gallon mixer which was preheated at about 60° C. The mixture was degassed and mixed under vacuum for 5 minutes. The vacuum was broken with nitrogen and then the DMDEE and tin catalyst, were added, followed by additional degassing and mixing under vacuum for minutes. The vacuum was broken again with nitrogen and then the filler mixture including silica if used was added into the mixer. Mixing was started to wet out the fillers for 2 minutes. Vacuum was applied and mixing continued for 15 minutes. After breaking the vacuum with nitrogen, the mixture was scraped down and the polyester prepolymer was added along with any stabilizers. Mixing under vacuum was conducted for 10 minutes. The resulting adhesive composition was packaged into airtight tubes which were stored in nitrogen filled sealed aluminium bags.

Quick Knife Adhesion

The test is performed on the following coupons:
1-inch×6-inch or 1-inch×4-inch glass covered on one side with a ceramic frit 2L-5350, a bismuth based press bent frit available from Johnson Matthey Inc.; 1-inch×4-inch metal coated with 2k polyurethane paint of Axalta RK8032; 1-inch×4-inch metal coated with 2k polyurethane paint of BASF 2K4; 1-inch×4-inch metal coated with silanated paint of Axalta GenIV;
Windshield glass with press bent enamel frit;
The quick knife adhesion test is performed by dispensing a bead of 6 mm (width)×6 mm (height)×100 mm (length) size on the tested substrate. The quick knife test is run after the initial cure of the bead under 23° C. and 50 percent RH (relative humidity) for a specific time period and any further environmental exposure. When tested, a slit (20-40 mm) is cut between the adhesive end and the substrate. The cured bead is then cut with a razor blade through to the tested substrate at a 60 degree angle while pulling back the end of the bead at >90 degree angle. Notches are cut about every 3-5 mm on the substrate. The degree of adhesion is evaluated as adhesive failure (AF), thin film failure (TF) and/or cohesive failure (CF). In case of AF, the cured bead can be separated from the tested substrate surface, while in CF, separation occurs within the sealant adhesive as a result of cutting and pulling and TF is a special case of CF in which there is a thin film of cured adhesive left on the substrate after cutting and testing.

The press flow viscosity on adhesive samples is measured by determining the amount of time (in seconds) for 20 g of the adhesive composition to pass through a 4.0 mm orifice under conditions of 552 kPa applied pressure at 23° C., unless otherwise specified.

The lap shear test is performed according to SAE J1529 test procedure which is described below. A triangle bead of adhesive composition approximately 10 mm base and 10 mm height is applied along the width of the 25 mm by 100 mm of a specified coupon, such as a Bismuth based press bent frit glass coupon, and about 6 mm away from the coupon end. The second substrate, which can be a painted metal coupon, is immediately pressed on the adhesive bead to give a final height of 6 mm for the composition in between. The sample is allowed to cure under conditions of 23° C. and 50 percent relative humidity (RH) for 7 days unless specified otherwise. The sample is then pulled right away or after more environmental exposures at a rate of 50 mm/min with an Instron Tester. The load (lbs) at sample break divided by the sample area (in²) gives the lap shear adhesion strength (psi). The degree of adhesion is evaluated as adhesive failure (AF), thin film failure (TF) and/or cohesive failure (CF). In case of AF, the cured bead can be separated from the tested substrate surface, while in CF, separation occurs within the sealant adhesive and TF is a special case of CF in which there is a thin film of cured adhesive left on the substrate after testing.

Round patties of adhesive samples are cured for 7 days at conditions of 23° C. and 50% relative humidity (RH). Test specimens are cut from these cured sample patties and tested for, tensile strength, elongation and Young's modulus (from 1 to 10% strain) with an Instron Tester, all according to ASTM D412 (Die C).

Sag performance is evaluated by the following method. A metal panel of 10 cm height and 30 cm long is placed vertically by its length. The adhesive composition, which is either before or after heat aging conditions, is dispensed as a right angle triangular bead along the top edge of the panel with a height of 1.8 cm and a base of 0.6 cm. After 30 minutes, the amount of drop or sag of the tip of the adhesive bead is measured in millimeters. If there is no sag from the bead tip, then the sag test result is zero millimeter.

TABLE 2
Compositions of inventive and comparative examples
(wt %, based on total weight of the adhesive)

| Ingredient (wt %) | E1 | E2 | E3 | E4 | CE1 | CE2 |
|---|---|---|---|---|---|---|
| Polyether prepolymer (A) | 60.62 | 61.62 | 62.66 | 62.52 | 59.55 | 59.23 |
| Polyester prepolymer (B) | 1.2 | 1.3 | 1.15 | 1.2 | — | 0.9 |
| DMDEE (F) | 0.22 | 0.3 | 0.14 | 0.2 | 0.35 | 0.21 |
| Tin catalyst (dimethyl tin dineodecanoate) | 0.02 | 0.02 | 0.02 | 0.02 | — | 0.021 |
| Aliphatic polyisocyanate (C) | 1.0 | 2.2 | 2.2 | 0.8 | — | 2.4 |
| Aromatic polyisocyanate (D) | 0.65 | 0.6 | 0.5 | 0.3 | — | 0.4 |
| Isocyanate functionalised silane (E) | 1.95 | 0.9 | 0.5 | 2.5 | 3.1 | — |
| Mercaptosilane (G) | 0.96 | 0.95 | 0.99 | 0.75 | — | 0.9 |
| Aminosilane (G′) | 0.12 | 0.15 | 0.11 | 0.15 | — | 0.2 |
| Carbon black (H) | 21.10 | 22.0 | 22.0 | 22.0 | 22.5 | 22.8 |
| Fumed silica, Filler (J) | — | 0.5 | 0.5 | — | 12.0 | — |
| Calcium carbonate (I) | 9.0 | 6.0 | 7.8 | 6.0 | — | 9.7 |
| Plasticizer (diisononylphthalate) | 3.16 | 3.16 | 1.18 | 3.16 | 2.0 | 2.99 |
| Stabilizer mixture | — | 0.3 | 0.25 | 0.4 | 0.5 | 0.25 |

TABLE 3
Quick Knife Adhesion results for adhesives of the invention and comparative
examples on different substrates with different humidity and heat treatments

| | | | | | |
|---|---|---|---|---|---|
| E1 | E2 | E3 | E4 | CE 1 | CE2 |

2K polyurethane paint (Axalta RK8032), primerless to paint

| | | | | | | |
|---|---|---|---|---|---|---|
| 7 day cure at 23° C. | 100% CF | 100% CF | 100% CF | 100% CF | 0% CF/ | — |
| and 50% relative | | | | | 100% AF | |
| humidity conditions | | | | | | |
| 7 day cure at 23° C. | 100% CF | 100% CF | 100% CF | 100% CF | — | — |
| and 50% relative | | | | | | |
| humidity conditions + | | | | | | |
| 14 day at 38° C./ | | | | | | |
| 100% relative | | | | | | |
| humidity | | | | | | |
| 7 day cure at 23° C. | 100% CF | — | — | — | — | — |
| and 50% relative | | | | | | |
| humidity conditions + | | | | | | |
| 14 day at 38° C./ | | | | | | |
| 100% RH + 10 | | | | | | |
| day at 90° C. | | | | | | |

Silanated paint (Axalta GenIV), primerless to paint

| | | | | | | |
|---|---|---|---|---|---|---|
| 7 day cure at 23° C. | 100% CF | 100% CF | 100% CF | 100% CF | 0% CF/ | — |
| and 50% relative | | | | | 100% AF | |
| humidity conditions | | | | | | |
| 7 day cure at 23° C. | 100% CF | 100% CF | 100% CF | 100% CF | — | — |
| and 50% relative | | | | | | |
| humidity conditions + | | | | | | |
| 14 day at 38° C./ | | | | | | |
| 100% relative | | | | | | |
| humidity | | | | | | |
| 7 day cure at 23° C. | 100% CF | — | — | — | — | — |
| and 50% relative | | | | | | |
| humidity conditions + | | | | | | |
| 14 day at 38° C./ | | | | | | |
| 100% relative | | | | | | |
| humidity + 10 days | | | | | | |
| at 90° C. | | | | | | |

2K polyurethane paint (BASF 2K4), primerless to paint

| | | | | | | |
|---|---|---|---|---|---|---|
| 7 day cure at 23° C. | 100% CF | — | — | — | 0% CF/ | — |
| and 50% relative | | | | | 100% AF | |
| humidity conditions | | | | | | |
| 7 day cure at 23° C. | 100% CF | — | — | — | — | — |
| and 50% relative | | | | | | |
| humidity + 14 day at | | | | | | |
| 38° C. /100% relative | | | | | | |
| humidity | | | | | | |
| 7 day cure at 23° C. | 100% CF | — | — | — | — | — |
| and 50% relative | | | | | | |
| humidity + 14 day at | | | | | | |
| 38° C. /100% relative | | | | | | |
| humidity + 10 day at | | | | | | |
| 90° C. | | | | | | |

Windshield glass with press bent enamel, primerless to glass

| | | | | | | |
|---|---|---|---|---|---|---|
| 7 day cure at 23° C. | 100% CF | 100% CF | 100% CF | 100% CF | 100% CF | — |
| and 50% relative | | | | | | |
| humidity conditions | | | | | | |
| 7 day cure at 23° C. | — | 100% CF | 100% CF | — | — | — |
| and 50% relative | | | | | | |
| humidity + 14 day | | | | | | |
| 38° C./100% Relative | | | | | | |
| Humidity | | | | | | |

2L-5350 press bent enamel glass, primerless to glass

| | | | | | | |
|---|---|---|---|---|---|---|
| 7 day cure at 23° C. | 100% CF | 100% CF | 100% CF | 100% CF | 100% CF | 98% AF |
| and 50% relative | | | | | | |
| humidity conditions | | | | | | |

The results show that the adhesive of the invention shows 100% cohesive failure with all substrates, even after 14 days humidity treatment and heat ageing for ten days at 90° C.

Table 4 shows the initial viscosity, heat age viscosity, heat age sag, tensile strength, elongation, and Young's modulus for Examples 1 through 4.

TABLE 4
initial viscosity, heat age viscosity, heat age sag, tensile strength, elongation,
and Young's modulus for Examples 1 through 4 and Comparative Examples 1 and 2

| Samples | CE1 | CE2 | Example 1 | | Example 2 | | Example 3 | | Example 4 | |
|---|---|---|---|---|---|---|---|---|---|---|
| initial Press | 36 sec | 32 sec | 17 | sec | 24 | sec | 32 | sec | 16 | sec |
| Flow Viscosity, | | | | | | | | | | |
| sec (552 KPa/ | | | | | | | | | | |
| 4 mm) | | | | | | | | | | |
| Press Flow | — | — | 29 | sec | 38 | sec | 46 | sec | 27 | sec |
| viscosity after | | | | | | | | | | |
| 3 day 54 C. Heat | | | | | | | | | | |
| Ageing, | | | | | | | | | | |
| (552 KPa/4 mm) | | | | | | | | | | |
| Sag after 3 day | — | — | 0 | | 0 | | 0 | | 0 | |
| 54 C., mm | | | | | | | | | | |
| T/E properties | | | | | | | | | | |
| (7 d cure at | | | | | | | | | | |
| 23 C./50% relative | | | | | | | | | | |
| humidity) | | | | | | | | | | |
| Tensile strength, | — | — | 962 | psi | 1114 | psi | 1189 | psi | 966 | psi |
| psi | | | | | | | | | | |
| Elongation. % | — | — | 303% | | 381% | | 421% | | 376% | |
| Young's | — | — | 3.88 | MPa | 4.01 | MPa | 4.22 | MPa | 3.34 | MPa |
| Modulus (1-10% | | | | | | | | | | |
| strain) | | | | | | | | | | |

All samples from Example 1 through 4 showed zero sag after 3 day at 54° C. heat age conditions, tensile strength more than 900 psi, elongation more than 300%, and Young's modulus more than 3 MPa.

TABLE 5
Shows lap shear adhesion data for Examples 2 and 3.

| Samples | Example 2 | | Example 3 | |
|---|---|---|---|---|
| Lapshear, | | | | |
| substrate 1: IPA wiped Bismuth based press | | | | |
| bent frit 2L-5350 | | | | |
| subtrate 2: IPA wiped Gen IV painted metal | | | | |
| coupon | | | | |
| 7 day cure at 23 C./50% relative humidity, psi | 674 | psi | 708 | psi |
| failure mode | 100% | CF | 100% | CF |
| 7 day cure at 23° C./50% relative humidity | 447 | psi | 496 | psi |
| plus 14 day 38° C./100% relative humidity, psi | | | | |
| failure mode | 100% | CF | 100% | CF |
| 7 day cure at 23° C./50% relative humidity | 555 | psi | 566 | psi |
| plus 14 day at 80° C., psi | | | | |
| failure mode | 100% | CF | 100% | CF |

Lapshear strength is more than 400 psi with 100% cohesive failure.

1. A one-component polyurethane adhesive composition comprising:
(A) at least one polyether prepolymer at a total content of polyether prepolymer of 30-75 wt %;
(B) at least one polyester prepolymer at a total content of polyester prepolymer of 0.5-2.0 wt %;
(C) at least one aliphatic polyisocyanate at a total aliphatic polyisocyanate content of 0.5-3.0 wt %;
(D) at least one aromatic polyisocyanate at a total aromatic polyisocyanate content of 0.2-2.0 wt %;
(E) at least one isocyanate functionalized silane at a total isocyanate functionalized silane content of 0.2-3.0 wt %;
(F) amine catalyst at 0.1-0.6 wt %;
(G) at least one mercaptosilane at a total mercaptosilane content of 0-1.5 wt % and/or (G′) at least one aminosilane at a total aminosilane content of 0-1.5 wt % wherein the combination of amino and/or mercaptosilane is at least 0.5 wt %;
(H) carbon black at 10-35 wt %;
(I) optionally calcium carbonate at 0-20 wt %;
(J) optionally filler other than carbon black and calcium carbonate, at 0-20 wt %;
(K) at least one organometallic catalyst capable of catalyzing the reaction of isocyanate with a functional group having at least one reactive hydrogen and silane condensation;
wherein the total polyisocyanate content is 1-5 wt %, the total of calcium carbonate plus filler is 0-20 wt %, and the weight percentages are based on the total weight of the polyurethane adhesive.

2. An adhesive composition according to claim 1, wherein the at least one polyether prepolymer (A) is made by polymerizing one or more polyols in the presence of a polyisocyanate, preferable diisocyanate, the polyether polyol may be selected from polyether polyols, hydroxyl containing polythioethers, polymer polyols, and mixtures thereof.

3. An adhesive composition according to claim 1, wherein the at least one polyether prepolymer is made by reacting a polyisocyanate with a polyether polyol.

4. An adhesive composition according to claim 1, wherein the polyether prepolymer is made by reacting a polyisocyanate with a polyol selected from poly(ethylene oxide)diol, poly(propylene oxide)diol, poly(butylene oxide)diol, poly(tetramethylene oxide)diol, poly(ethylene oxide)triol, poly(propylene oxide)triol, poly(butylene oxide)triol, poly(tetramethylene oxide)triol, and mixtures of these.

5. An adhesive composition according to claim 1, wherein the polyether prepolymer is made by reacting a polyisocyanate selected from toluene diisocyanate (TDI), hexamethylene diisocyanate (HDI), naphthalene diisocyanate (NDI), methylene bis-cyclohexylisocyanate (HMDI) (hydrogenated MDI), isophorone diisocyanate (IPDI), and mixtures of these, with a difunctional polyether polyol selected from poly(alkylene oxide)diols, where the alkylene group is C₂ to C₄, a trifunctional polyols based on poly(akylene oxide)triols initiated with a trifunctional polyol, where the alkylene group is C₂ to C₄, and mixtures of these.

6. An adhesive composition according to claim 1, wherein the polyether prepolymer comprises a nominally trifunctional poly(propylene oxide) having a hydroxyl number of 36 (equivalent weight 1558), and a nominally difunctional poly(propylene oxide) having a hydroxyl number of 56 (equivalent weight 1000) reacted with MDI.

7. An adhesive composition according to claim 1, wherein the at least one polyester prepolymer (B) is made by reacting one or more linear copolyesters with primary hydroxyl functionality with a polyisocyanate, preferably a diisocyanate.

8. An adhesive composition according to claim 1, wherein the at least one polyester prepolymer (B) is made by reacting one or more linear copolyesters with primary hydroxyl functionality with a polyisocyanate selected from toluene diisocyanate (TDI), hexamethylene diisocyanate (HDI), naphthalene diisocyanate (NDI), methylene bis-cyclohexylisocyanate (HMDI) (hydrogenated MDI), isophorone diisocyanate (IPDI) and mixtures of these.

9. An adhesive composition according to any claim 1, wherein the at least one polyester prepolymer (B) is made by reacting a copolyester of molecular weight of 3,500 Da with MDI.

10. An adhesive composition according to claim 1, wherein the at least one aliphatic polyisocyanate (C) is selected from isophorone diisocyanate, 1,6-hexamethylene diisocyanate, bis(4-isocyanatocyclohexyl)methane, and trimethyl hexamethylene diisocyanate, any of which can be modified to include biuret, allophonate, urea, carbamate, isocyanurate or carbodiimide groups.

11. An adhesive composition according to claim 1, wherein the at least one aliphatic polyisocyanate (C) is based on HDI trimer.

12. An adhesive composition according to claim 1, wherein the at least one aromatic polyisocyanate (D) is selected from diphenylmethane diisocyanate (MDI), polymethylene polyphenylisocyanates, polymeric MDI (PMDI, a mixture of diphenylmethane diisocyanate and polymethylene polyphenylioscyanates), tetramethylxylene diisocyanate, toluene diisocyanate, any of which can be modified to include biuret, allophonate, urea, carbamate, isocyanurate or carbodiimide groups.

13. An adhesive composition according to claim 1, wherein the at least one aromatic polyisocyanate (D) is polymethylene polyphenylisocyanate.

14. An adhesive composition according to claim 1, wherein the at least one isocyanate functionalized silane (E) is selected from silanes made by reacting a polyisocyanate compound with an active hydrogen-containing group W of a silicone compound of the formula: 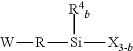
wherein W is an active hydrogen-containing group selected from the group consisting of a hydroxyl group, a carboxyl group, a mercapto group, a primary amino group and a secondary amino group, X is hydrolysable alkoxy group, and R⁴ is a C₁-C₂₀ alkyl, a C₆-C₂₀ aryl, a C₁-C₂₀ aralkyl group, R is selected from C₁-C₂₀ hydrocarbon groups, particularly a propylene (—CH₂CH₂CH₂—) group, and b is 0, 1 or 2.

15. An adhesive composition according to claim 1, wherein the at least one isocyanate functionalized silane (E) is a reaction product of N,N-bis[(3-trimethoxysilyl)-propyl]amine) reacted with HDI-Biuret.

16. An adhesive composition according claim 1, wherein the amine catalyst (F) is a tertiary amine catalyst.

17. An adhesive composition according to claim 1, wherein the amine catalyst (F) is selected from N,N-dimethylcyclohexane, triethylenediamine, N,N,N,N-tetramethylalkylenediamine, N,N,N,N-pentamethyldiethylenetriamine, triethylamine, N,N-dimethylbenzylamine, N,N-dimethylhexadecylamine, N,N-dimethylbutylamine, 2,2′-dimorpholinodiethyl ether, and mixtures of these.

18. An adhesive composition according to claim 1, wherein the amine catalyst (F) is 2,2′-dimorpholinodiethyl ether.

19. An adhesive composition according to claim 1, wherein the at least one mercaptosilane (G) is of the following formula: 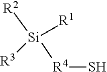
where R¹, R² and R³ are independently selected from OCH₃ and OC₂H₅;
and R⁴ is —CₙH₂ₙ— where n is an integer of 1 to 12.

20-50. (canceled)

51. An adhesive composition comprising:
(A) at least one polyether prepolymer which comprises a nominally trifunctional poly(propylene oxide) having a hydroxyl number of 36 (equivalent weight 1558), and a nominally difunctional poly(propylene oxide) having a hydroxyl number of 56 (equivalent weight 1000) reacted with MDI, at a total content of polyether prepolymer of 30-75 wt %;
(B) at least one polyester prepolymer which is made by reacting a copolyester of molecular weight of 3,500 Da with MDI at a total content of polyester prepolymer of 0.5-2.0 wt %;
(C) at least one aliphatic polyisocyanate which is based on HDI trimer at a total aliphatic polyisocyanate content of 0.5-3.0 wt %;
(D) at least one aromatic polyisocyanate which is polymethylene polyphenylisocyanate at a total aromatic polyisocyanate content of 0.2-2.0 wt %;
(E) at least one isocyanate functionalized silane which is a reaction product of N,N-bis[(3-trimethoxysilyl)-propyl]amine) reacted with HDI-Biuret, at a total isocyanate functionalized silane content of 0.2-3.0 wt %;
(F) amine catalyst which is 2,2′-dimorpholinodiethyl ether at 0.1-0.6 wt %;
(G) at least one mercaptosilane which is gamma-mercaptopropyltrimethoxysilane at a total mercaptosilane content of 0-1.5 wt % and/or (G′) at least one aminosilane which is bis(gamma-trimethoxysilylpropyl)amine at a total aminosilane content of 0-1.5 wt % wherein the combination of amino and/or mercaptosilane is at least 0.5 wt %;
(H) carbon black at 10-35 wt %;
(I) optionally calcium carbonate at 0-20 wt %;
(J) optionally filler other than carbon black and calcium carbonate, at 0-20 wt %;
(K) at least one organometallic catalyst which is dimethyl tin dineodecanoate;
wherein the total polyisocyanate content is 1-5 wt %, the total of calcium carbonate plus filler is 3-20 wt %, and the weight percentages are based on the total weight of the polyurethane adhesive.

52. (canceled)
